(19) United States
(12) Patent Application Publication
(10) Pub. No.: US 2020/0244970 A1
(43) Pub. Date: Jul. 30, 2020

(54) VIDEO PROCESSING METHOD, DEVICE, AERIAL VEHICLE, SYSTEM, AND STORAGE MEDIUM

(71) Applicant: SZ DJI TECHNOLOGY CO., LTD., Shenzhen (CN)

(72) Inventors: Ying CHEN, Shenzhen (CN); Xuke WU, Shenzhen (CN); Tao HU, Shenzhen (CN)

(21) Appl. No.: 16/844,359

(22) Filed: Apr. 9, 2020

Related U.S. Application Data
(63) Continuation of application No. PCT/CN2017/112115, filed on Nov. 21, 2017.

(51) Int. Cl. H04N 19/154; B64C 39/02; H04N 19/166

(52) U.S. Cl. CPC H04N 19/154; B64C 39/024; B64C 2201/127; B64C 2201/123; H04N 19/166

(57) ABSTRACT

A video processing method includes obtaining a video-to-be-edited, obtaining a predicted capacity value of a wireless channel capacity in a current environment, obtaining a predicted encoding parameter for the video-to-be-edited, adjusting a currently configured encoding parameter based on the predicted capacity value and the predicted encoding parameter, and encoding the video-to-be-edited based on the adjusted encoding parameter to obtain an encoded stream. The video-to-be-edited is a video captured by a camera device mounted on an aerial vehicle during a flight of the aerial vehicle.

### CROSS-REFERENCE TO RELATED APPLICATION

This application is a continuation of International Application No. PCT/CN2017/112115, filed Nov. 21, 2017, the entire content of which is incorporated herein by reference.

### TECHNICAL FIELD

The present disclosure relates to the field of control technology, and in particular relates to a video processing method, device, aerial vehicle, system, and storage medium.

### BACKGROUND

With the development of computer technology, the development of aerial vehicle such as unmanned aerial vehicles (UAVs) is getting faster and faster. Among them, UAVs capable of capturing images or videos mainly include a gimbal, a photographing device, and a body. Such UAVs can capture images or videos of various environments according to user's needs. When the UAV is in operation for photographing, the gimbal is usually mounted underneath or on top of the UAV. By the rotation of the gimbal, the photographing device mounted on the gimbal may capture images or videos of the environments at different angles relative to the UAV, and the UAV outputs the captured video or images to the display terminal.

However, the output display of the video is often accompanied by phenomena such as interruptions, faltering, and nonuniformity. Accordingly, how to better encode the video for convenient transmission has become a popular topic for research.

### SUMMARY

In accordance with the disclosure, there is provided a video processing method. The video processing method includes obtaining a video-to-be-edited, obtaining a predicted capacity value of a wireless channel capacity in a current environment, obtaining a predicted encoding parameter for the video-to-be-edited, adjusting a currently configured encoding parameter based on the predicted capacity value and the predicted encoding parameter, and encoding the video-to-be-edited based on the adjusted encoding parameter to obtain an encoded stream. The video-to-be-edited is a video captured by a camera device mounted on an aerial vehicle during a flight of the aerial vehicle.

Also in accordance with the disclosure, there is provided a video processing device. The video processing device includes a memory configured to store program instructions, and a processor configured to execute the program instructions stored in the memory. When executed, the program instructions cause the processor to: obtain a video-to-be-edited, the video-to-be-edited being a video captured by a camera device mounted on an aerial vehicle during a flight of the aerial vehicle; obtain a predicted capacity value of a wireless channel capacity in a current environment; obtain a predicted encoding parameter for the video-to-be-edited; adjust a currently configured encoding parameter based on the predicted capacity value and the predicted encoding parameter; and encode the video-to-be-edited based on the adjusted encoding parameter to obtain an encoded stream.

### BRIEF DESCRIPTION OF THE DRAWINGS

FIG. 1 is a schematic structural diagram of a video processing system according to some embodiments of the present disclosure;

FIG. 2 is a schematic structural diagram of another video processing system according to some embodiments of the present disclosure;

FIG. 3 is a schematic structural diagram of a process for video processing according to some embodiments of the present disclosure;

FIG. 4 illustrates a flowchart of a video processing method according to some embodiments of the present disclosure;

FIG. 5 illustrates a flowchart of another video processing method according to some embodiments of the present disclosure;

FIG. 6 is a schematic diagram of a wireless channel capacity according to some embodiments of the present disclosure; and

FIG. 7 is a schematic structural diagram of a video processing device according to some embodiments of the present disclosure.

### DETAILED DESCRIPTION OF THE EMBODIMENTS

In the following, the technical solutions in the embodiments of the present disclosure will be clearly and completely described with reference to the drawings in the embodiments of the present disclosure. Apparently, the described embodiments are only a part of the embodiments of the present disclosure, but not all of the embodiments. Based on the embodiments of the present disclosure, all other embodiments obtained by a person of ordinary skill in the art without creative efforts shall fall within the protected scope of the present disclosure.

Below some embodiments of the present disclosure will be described in detail with reference to the drawings. When no conflicts exist, the following embodiments and features in the embodiments may be combined with each other.

According to some embodiments of the present disclosure, a video processing method may be executed by a video processing device. The video processing device may be disposed on an aerial vehicle (such as a UAV) capable of recording videos, or may be disposed on a remote control on the ground. The video processing method may be applied to an aerial vehicle-based video shooting task. In other embodiments, it can also be applied to a video recording task of a movable device such as a robot capable of autonomous movement. The following is an example of a video processing method for an aerial vehicle.

During a flight of the aerial vehicle, the video processing device may obtain a video-to-be-edited and captured by a photographing device mounted on the aerial vehicle, and transmit the video-to-be-edited to a display terminal for display. In one embodiment, during the process in which the video processing device transmits the video-to-be-edited to the display terminal, the video processing device may monitor a wireless channel to predict a capacity of the wireless channel in a current environment, to obtain the predicted capacity value. The video processing device may collect statistics of encoding data of historical videos, and determine predicted encoding parameter of the video to be edited. Further, the video processing device may adjust a currently configured encoding parameter based on the predicted capacity value and the predicted encoding parameter, and encode the video-to-be-edited based on the adjusted encoding parameter to obtain an encoded stream. The video processing device transmits the encoded stream to the display terminal via the wireless channel, so that the display terminal outputs the video-to-be-edited by decoding the encoded stream.

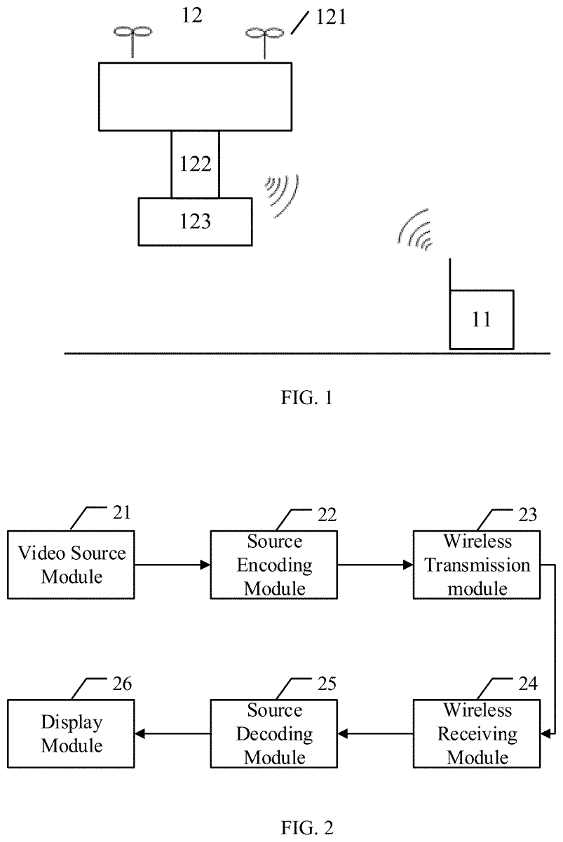

Referring to FIG. 1, according to some embodiments of the present disclosure, FIG. 1 is a schematic structural diagram of a video processing system. The system includes a video processing device 11 and an aerial vehicle 12. The video processing device 11 may be a control terminal of the aerial vehicle 12, and may be, e.g., any one or more of: a remote control, a smart phone, a tablet computer, a laptop computer, a ground station and a wearable device (e.g., watch, bracelet). For example, the aerial vehicle 12 may be a rotor-type UAV, such as a quad-rotor UAV, a six-rotor UAV, an eight-rotor UAV, or a fixed-wing UAV. The aerial vehicle 12 includes a power system 121 for supplying flight power to the aerial vehicle 12. The power system 121 includes any one or more of: a propeller, a motor, and an electronic speed control (ESC). The aerial vehicle 12 may further include a gimbal 122 and an imaging device 123, and the imaging device 123 is mounted on a body of the UAV by the gimbal 122. The imaging device 123 is configured to capture images or videos during the flight of the aerial vehicle 12. The camera device includes, but is not limited to, a multispectral imaging device, a hyperspectral imaging device, a visible light camera and an infrared camera. The gimbal 122 is a multi-axis movement and stabilization system. The gimbal motor compensates a photographing angle of the imaging device by adjusting a rotation angle of a rotation shaft, and prevents or decreases shaking of the imaging device by setting an appropriate buffer mechanism.

In some embodiments, the video processing device 11 may be equipped with an interactive device for interacting with a user. The interactive device may be any one or more of: a touch screen, a keyboard, a button, a rocker and a wheel. A user interface may be provided on the video processing device 11, and the video processing device 11 may output an encoded video to the user interface for display.

In some embodiments, the video processing device 11 may obtain a video-to-be-edited captured by the imaging device 123 during the flight of the aerial vehicle 12, and the video processing device 11 may perform an encoding process to the obtained video-to-be-edited, and transmitting the encoded stream obtained from the encoding process to the user interface of the display terminal for display via a wireless channel.

In some embodiments, the video processing device 11 may monitor a wireless channel and obtain a historical channel capacity value of the wireless channel in real time. The video processing device 11 may predict the wireless channel capacity in the current environment based on the historical channel capacity value, and obtain the predicted capacity value for the wireless channel to transmit the video-to-be-edited. In one embodiment, the video processing device 11 may obtain the historical channel capacity value of the wireless channel in a first preset time range. The first preset time range refers to a preset time range before a current time. The video processing device 11 may determine the predicted capacity value of the wireless channel in the current environment based on the historical channel capacity value.

In some embodiments, the video processing device 11 may collect statistics of encoding data of historical videos obtained within a second preset time range, and determine predictive encoding parameters for encoding the video-to-be-edited based on the collected statistics of the encoding data of the historical videos. In some embodiments, the video processing device 11 may adjust a currently configured encoding parameter based on the predicted capacity value and the predicted encoding parameter, and encode the video-to-be-edited based on the adjusted encoding parameter, thereby obtaining an encoded stream (e.g., encoded video data stream).

The video processing system may include video source module, source encoding module, wireless transmission module, wireless receiving module, source encoding module, and display module. As shown in FIG. 2, FIG. 2 is a schematic structural diagram of another video processing system according to some embodiments of the present disclosure. As shown in FIG. 2, the system includes a video source module 21, a source encoding module 22, a wireless transmission module 23, a wireless receiving module 24, a source encoding module 25, and a display module 26. The video source module 21 is configured to obtain a video-to-be-edited and send the video-to-be-edited to the source encoding module 22. The source encoding module 22 is configured to encode the obtained video-to-be-edited to generate an encoded stream, and send the encoded stream to the wireless receiving module 24 via a first wireless channel through the wireless transmission module 23. The wireless receiving module 24 sends the received code stream to the source encoding module 25 (e.g., via a second wireless channel or a wired connection). The source encoding module 25 decodes the encoded stream to acquire the video-to-be-edited obtained by the video source module 21, and transmits the decoded video-to-be-edited to the display module 26 for display.

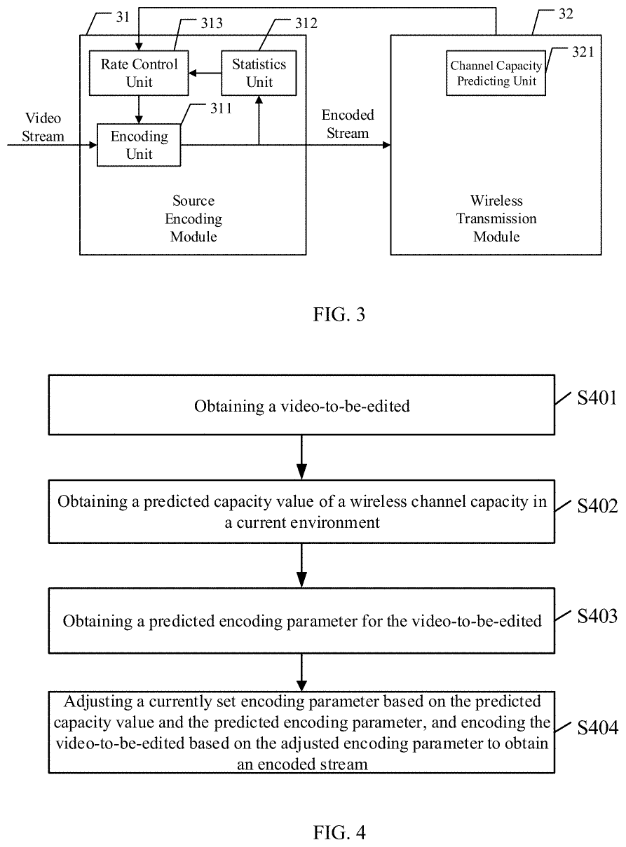

In some embodiments of the present disclosure, the process of encoding the obtained video-to-be-edited can be specifically described in FIG. 3 as an example. FIG. 3 is a schematic structural diagram of a process for video processing according to some embodiments of the present disclosure. As shown in FIG. 3, the video processing device can obtain a video captured by a camera device mounted on the aerial vehicle during the flight of the aerial vehicle, and the video processing device can obtain a video stream corresponding to the video from a source encoding module 31. The source encoding module 31 includes an encoding unit 311, a statistics unit 312, and a rate control unit 313. The encoding unit 311 may encode the obtained video stream to obtain an encoded stream, and transmit the encoded stream to the wireless transmission module 32. The wireless transmission module 32 includes a channel capacity predicting unit 321.

In some embodiments, the channel capacity predicting unit 321 may determine the predicted capacity value of the wireless channel in the current environment based on the obtained historical channel capacity value of the wireless channel within the first preset time range. The first preset time range is a preset time range before the current time, such as within one minute before the current time. The historical channel capacity value is an actual bitrate for transmitting an encoded stream (e.g., earlier portion of the current code stream or historical code stream) by the wireless channel within the first preset time range. The predicted capacity value is a predicted theoretical maximum code rate for transmitting the encoded stream corresponding to the video-to-be-edited by the wireless channel within a current time range. In one embodiment, the channel capacity predicting unit 321 may forward the obtained predicted capacity value of the wireless channel to the rate control unit 313 in the source encoding module 31. The rate control unit 313 may determine a target bitrate based on the obtained predicted capacity value. The target bitrate is a theoretical maximum bitrate for transmitting an encoded stream for the video-to-be-edited by the wireless channel.

In some embodiments, the statistics unit 312 may collect statistics of the encoding data of the historical videos. The encoding data is obtained by the encoding unit 311 which encodes the historical videos within a second preset time range. The statistics unit 312 may determine the predicted encoding parameter of the video-to-be-edited based on the collected statistics of the encoding data, and transmit the determined predicted encoding parameter to the rate control unit 313. In some embodiments, the rate control unit 313 may adjust a currently configured encoding parameter according to the obtained target bitrate and the predicted encoding parameter, and transmits the adjusted encoding parameter to the encoding unit 311. The encoding unit 311 encodes the video-to-be-edited based on the received adjusted encoding parameters to obtain an encoded stream.

The video processing method provided by the embodiments of the present disclosure may be applied to a video recording task of an aerial vehicle. The following describes a control method applied on an aerial vehicle with reference to the accompanying drawings.

Referring to FIG. 4, FIG. 4 illustrates a flowchart of a video processing method according to some embodiments of the present disclosure. The method may be performed by a video processing device. The specific explanation of the video processing device is as described above. Specifically, the method according to the embodiments of the present disclosure includes the following steps.

S401: Obtaining a video-to-be-edited.

In some embodiments of the present disclosure, the video processing device may obtain a video-to-be-edited, and the video-to-be-edited is a video captured by a camera device mounted on an aerial vehicle during a flight of the aerial vehicle.

S402: Obtaining a predicted capacity value of a wireless channel capacity in a current environment.

In some embodiments of the present disclosure, the video processing device may obtain a predicted capacity value of a wireless channel capacity in the current environment. Specifically, the video processing device may monitor a wireless channel, and by monitoring the wireless channel, a historical channel capacity value may be obtained. The video processing device may predict a capacity value of the wireless channel capacity in the current environment based on the historical channel capacity value. Accordingly, in the embodiments of the present disclosure, a time/duration for each frame of video to be transmitted through the wireless channel may be controlled to be as even as possible by monitoring the wireless channel and predicting a capacity of the wireless channel, thereby decreasing a transmission delay.

In some embodiments, the video processing device may obtain the historical channel capacity value of the wireless channel within a first preset time range, and determine a predicted capacity value of the wireless channel in the current environment based on the historical channel capacity value. The first preset time range is a time range before a current time, and the historical channel capacity value is an actual bitrate for transmitting the encoded stream by the wireless channel within the first preset time range. Specifically, for example, when the video processing device obtains a bitrate for transmitting an encoded video data stream by the wireless channel within one minute before the current time (the first preset time range), the video processing device may determine the historical channel capacity value of the wireless channel within one minute before the current time according to the obtained bitrate. The video processing device may predict a maximum bitrate for transmitting the encoded stream of an encoded video by the wireless channel in a current environment based on the historical channel capacity value, and determine a predicted capacity value for transmitting the encoded video-to-be-edited by the wireless channel based on the predicted maximum bitrate.

S403: Obtaining a predicted encoding parameter for the video-to-be-edited.

In the embodiments of the present disclosure, the video processing device may obtain a predicted encoding parameter for the video-to-be-edited. In some embodiments, the video processing device may acquire encoding data obtained by encoding a historical video within a second preset time range, and determine a predicted encoding parameter of the video-to-be-edited based on the encoding data. The second preset time range is a preset time range before the current time. For example, in the process of encoding the historical video within two minutes before the current time, the video processing device may collect statistics of the encoding data of the historical video. The encoding data includes encoding parameters. The video processing device may determine predicted encoding parameters of the video-to-be-edited at the current time based on the collected statistics of the encoding data obtained by encoding the historical video.

S404: Adjusting a currently configured encoding parameter based on the predicted capacity value and the predicted encoding parameter, and encoding the video-to-be-edited based on the adjusted encoding parameter to obtain an encoded stream.

In the embodiments of the present disclosure, the video processing device may adjust a currently set encoding parameter based on the predicted capacity value and the predicted encoding parameter, and encode the video-to-be-edited based on the adjusted encoding parameter to obtain an encoded stream. In some embodiments, the video processing device may determine a target bitrate based on the predicted capacity value. The target bitrate is a theoretical maximum bitrate for transmitting the encoded stream by the wireless channel, and adjusting the currently configured encoding parameter based on the target bitrate and the predicted encoding parameter. The video processing device may encode the video-to-be-edited based on the adjusted encoding parameter to obtain a cold stream. Accordingly, in the embodiments of the present disclosure, the encoding parameter of the video-to-be-edited can be adjusted by predicting the capacity of the wireless channel and predicting the encoding parameter, so as to ensure an output of an encoded stream at a stable bitrate.

In the embodiments of the present disclosure, when a video-to-be-edited is obtained, the video processing device obtains a predicted capacity value of a wireless channel capacity in a current environment and a predicted encoding parameter of the video-to-be-edited, and adjusts a currently configured encoding parameter, encodes the video-to-be-edited based on the adjusted encoding parameter to obtain an encoded stream to improve the stability of a video transmission and reduce a maximum delay jitter.

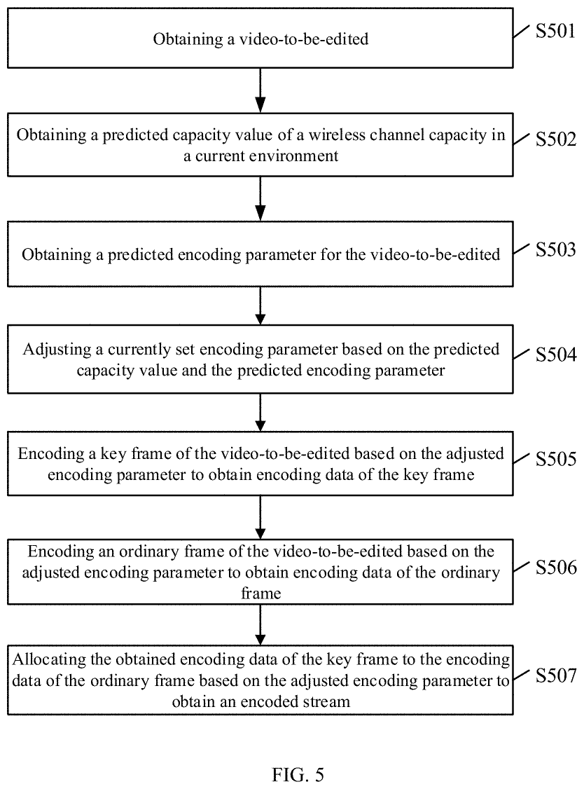

Referring to FIG. 5, according to some embodiments of the present disclosure, FIG. 5 illustrates a flowchart of another video processing method. The method may be performed by a video processing device. The specific explanation of the video processing device is as described above. The difference between the present embodiment and the embodiment shown in FIG. 2 is that in the present embodiment, encoding data of a key frame of the video-to-be-edited obtained by encoding the key frame is allocated to encoding data of an ordinary frame of the video-to-be-edited obtained by encoding the ordinary frame.

S501: Obtaining a video-to-be-edited.

In the embodiments of the present disclosure, the video processing device may obtain a video-to-be-edited. The video-to-be-edited is a video captured by a camera device mounted on an aerial vehicle during a flight of the aerial vehicle.

S502: Obtaining a predicted capacity value of a wireless channel capacity in a current environment.

In the embodiments of the present disclosure, the video processing device may obtain a predicted capacity value of a wireless channel capacity in a current environment. Specifically, the video processing device may obtain a historical channel capacity value of the wireless channel by monitoring the wireless channel, and predict the predicted capacity value of the wireless channel capacity in the current environment based on the historical channel capacity value.

In some embodiments, the video processing device may obtain the historical channel capacity value of the wireless channel within a first preset time range, and determine the predicted capacity value of the wireless channel in the current environment based on the historical channel capacity value. The first preset time range is a time range before the current time, and the historical channel capacity value is an actual bitrate for transmitting the encoded stream by the wireless channel within the first preset time range. The specific examples are described above, and are not described herein again.

S503: Obtaining a predicted encoding parameter for the video-to-be-edited.

In the embodiments of the present disclosure, the video processing device may obtain a predictive encoding parameter for the video-to-be-edited. In some embodiments, the video processing device may obtain encoding data obtained by encoding a historical video within a second preset time range, and determine the predicted encoding parameter of the video-to-be-edited based on the encoding data. The second preset time range is a preset time range before the current time. For example, in the process of encoding the historical video within two minutes before the current time, the video processing device may collect statistics of the encoding data obtained during the encoding process. The encoding data includes encoding parameters. The video processing device may predict the encoding parameter of the video-to-be-edited at a current time based on the obtained encoding data of the historical video, and determine the predicted encoding parameter of the video-to-be-edited at the current time.

S504: Adjusting a currently configured encoding parameter based on the predicted capacity value and the predicted encoding parameter.

In the embodiments of the present disclosure, the video processing device may adjust a currently set encoding parameter based on the predicted capacity value and the predicted encoding parameter. In some embodiments, the video processing device may determine a target bitrate based on the predicted capacity value. The target bitrate is a theoretical maximum bitrate for transmitting the encoded stream by the wireless channel. The video processing device may adjust a currently configured encoding parameter based on the target bitrate and the predicted encoding parameter.

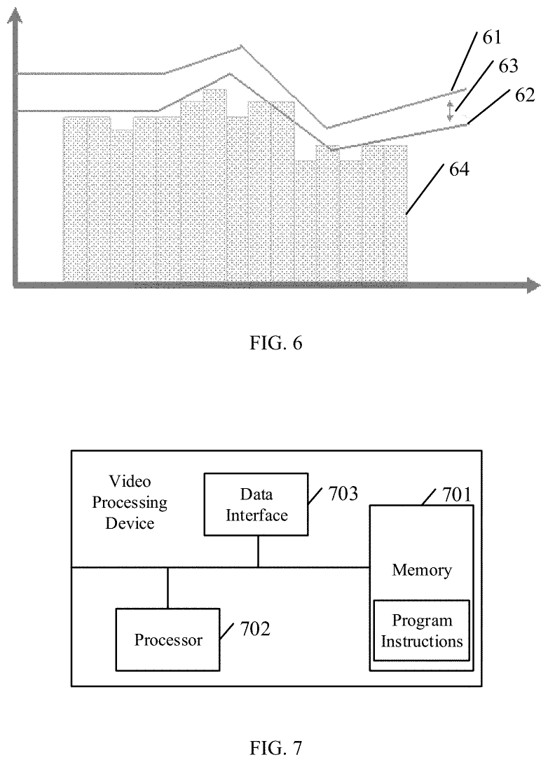

In some embodiments, the video processing device may determine a target capacity value based on the predicted capacity value and a preset capacity margin, and determine a target bitrate for transmitting an encoded stream by the wireless channel based on the target capacity value. Specifically, taking FIG. 6 as an example for illustration. FIG. 6 is a schematic diagram of a wireless channel capacity according to some embodiments of the present disclosure. As shown in FIG. 6, the video processing device may determine a target capacity value 62 based on a predicted capacity value 61 and a preset capacity margin 63. The preset capacity margin may be an artificially set arbitrary value, e.g., a value set by a user. The video processing device may determine the target bitrate for transmitting an encoded stream by the wireless channel based on the target capacity value 62. The wireless channel controls the transmitted code stream to be at an actual bitrate 64. Accordingly, in the embodiments of the present disclosure, a sufficient preset capacity margin is reserved in the encoded stream control process, thereby decreasing an influence of a drastic change of the wireless channel on the delay jitter, and avoiding a congestion in the wireless channel.

In some embodiments, the video processing device may determine a target encoding parameter based on the target bitrate and the predicted encoding parameter, and adjust a currently configured encoding parameter based on the target encoding parameter. In some embodiments, the video processing device may determine whether a bitrate corresponding to the predicted encoding parameter is greater than the target bitrate, and determine an encoding parameter corresponding to the target bitrate as the target encoding parameter if a detected result is positive, or determine the precited encoding parameter as the target encoding parameter if the detected result is negative.

S505: Encoding a key frame of the video-to-be-edited based on the adjusted encoding parameter to obtain encoding data of the key frame.

In the embodiments of the present disclosure, the video processing device may encode a key frame of the video-to-be-edited based on the adjusted encoding parameter to obtain encoding data of the key frame. In some embodiments, the video processing device may encode the video-to-be-edited by using a gradual decoder refresh (GDR) encoding method. During the encoding process, video frames of the video-to-be-edited is mainly divided into I frames (key frames) and P frames (ordinary frames). The video processing device may encode the I frame to obtain encoding data of the I frame.

S506: Encoding an ordinary frame of the video-to-be-edited based on the adjusted encoding parameter to obtain encoding data of the ordinary frame.

In the embodiment of the present disclosure, the video processing device may encode an ordinary frame of the video-to-be-edited based on the adjusted encoding parameter to obtain coding data of the ordinary frame. In some embodiments, the video processing device may encode the video-to-be-edited by using the above-mentioned GDR encoding method. During the encoding process, the video frames of the video-to-be-edited are mainly divided into I frames (key frames) and P frames (ordinary frames). The video processing device may encode the P frame to obtain encoding data of the P frame.

S507: Allocating the obtained encoding data of the key frame to the encoding data of the ordinary frame based on the adjusted encoding parameter to obtain an encoded stream.

In the embodiments of the present disclosure, the video processing device may allocate the obtained encoding data of the key frame to the encoding data of the ordinary frame based on the adjusted encoding parameter to obtain an encoded stream. In some embodiments, the video processing device may allocate the encoding data of the I frame obtained by the GDR encoding method to the encoding data of the P frame based on the adjusted encoding parameter, so as to reduce size differences between the P frame and the I frame and reduce the transmission delay, thereby decreasing a minimum transmission delay jitter and avoiding channel congestion.

In the embodiments of the present disclosure, the video processing device adjusts a currently set encoding parameter based on the obtained predicted capacity value and predicted encoding parameter, and encodes a key frame of the video-to-be-edited based on the adjusted encoding parameter to obtain the encoding data of the key frame, and encodes an ordinary frame of the video-to-be-edited based on the adjusted encoding parameter to obtain the encoding data of the ordinary frame, and allocates the obtained coding data of the key frame to the encoding data of the ordinary frame, to obtain an encoded stream, which improves the stability of the video transmission and decreases the maximum delay jitter.

Referring to FIG. 7, according to some embodiments of the present disclosure, FIG. 7 is a schematic structural diagram of a video processing device. Specifically, the video processing device includes: a memory 701, a processor 702, and a data interface 703.

The memory 701 may include a volatile memory. The memory 701 may also include a non-volatile memory. The memory 701 may further include a combination of the foregoing types of memories. The processor 702 may be a central processing unit (CPU). The processor 702 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), or any combination thereof.

Further, the memory 701 is configured to store program instructions. When the program instructions are executed, the processor 702 may call the program instructions stored in the memory 701 to perform the following steps: acquiring a video-to-be-edited, the video-to-be-edited being a video captured by a camera device mounted on an aerial vehicle during a flight of the aerial vehicle; obtaining a predicted capacity value of a wireless channel capacity in a current environment; obtaining a predicted encoding parameter for the video-to-be-edited; and adjusting a currently configured encoding parameter based on the predicted capacity value and the predicted encoding parameter, and encoding the video-to-be-edited based on the adjusted encoding parameter to obtain an encoded stream.

The processor 702 may call the program instructions stored in the memory 701 to perform the following steps: acquiring a historical channel capacity value of the wireless channel in a first preset time range; and determining the predicted capacity value of the wireless channel in the current environment based on the historical channel capacity value.

The processor 702 may call the program instructions stored in the memory 701 to perform the following steps: acquiring encoding data obtained by encoding a historical video within a second preset time range; and determining a predicted encoding parameter of the video-to-be-edited based on the encoding data.

The processor 702 may call the program instructions stored in the memory 701 to perform the following steps: determining a target bitrate based on the predicted capacity value, the target bitrate being a theoretical maximum bitrate for transmitting the encoded stream by the wireless channel; and adjusting a currently configured encoding parameter based on the target bitrate and the predicted encoding parameter.

The processor 702 may call the program instructions stored in the memory 701 to perform the following steps: determining a target capacity value based on the predicted capacity value and a preset capacity margin; and determining the target bitrate for transmitting the encoded stream by the wireless channel based on the target capacity value.

The processor 702 may call the program instructions stored in the memory 701 to perform the following steps: determining a target encoding parameter based on the target bitrate and the predicted encoding parameter; and adjusting the currently configured encoding parameter based on the target encoding parameter.

The processor 702 may call the program instructions stored in the memory 701 to perform the following steps: detecting whether a bitrate corresponding to the predicted encoding parameter is greater than the target bitrate; determining an encoding parameter corresponding to the target bitrate to be the target encoding parameter if the detected result is positive; and determining the predicted encoding parameter to be a target encoding parameter if the detected result is negative.

The processor 702 may call the program instructions stored in the memory 701 to perform the following step: encoding a key frame of the video-to-be-edited based on the adjusted encoding parameter to obtain encoding data of the key frame.

The processor 702 may call the program instructions stored in the memory 701 to perform the following step: encoding an ordinary frame of the video-to-be-edited based on the adjusted encoding parameter to obtain encoding data of the ordinary frame.

The processor 702 may call program instructions stored in the memory 701 to perform the following step: allocating the encoding data of the key frame to the encoding data of the ordinary frame based on the adjusted encoding parameter.

In the embodiments of the present disclosure, when a video-to-be-edited is obtained, the video processing device obtains a predicted capacity value of a wireless channel capacity in a current environment and a predicted encoding parameter of the video-to-be-edited, adjusts a currently configured encoding parameter, encodes the video-to-be-edited based on the adjusted encoding parameter to obtain an encoded stream, thereby improving the stability of the video transmission and decreasing the maximum delay jitter.

Some embodiments of the present disclosure also provide an aerial vehicle, including: a body; a power system disposed on the body configured to supply flight power; and a processor configured to: acquire a video-to-be-edited, the video-to-be-edited being captured by a camera device mounted on the aerial vehicle during a flight of the aerial vehicle; acquire a predicted capacity value of a wireless channel capacity in a current environment; acquire a predicted encoding parameter for the video-to-be-edited; adjust a currently config encoding parameter based on the predicted capacity value and the predicted encoding parameter; and encodes the video-to-be-edited based on the adjusted encoding parameter to obtain an encoded stream.

Further, the processor is further configured to perform the following steps: acquiring a historical channel capacity value of the wireless channel in a first preset time range; and determining the predicted capacity value of the wireless channel in the current environment based on the historical channel capacity value.

Further, the processor is further configured to perform the following steps: acquiring encoding data obtained by encoding a historical video within a second preset time range; and determining the predicted encoding parameter of the video-to-be-edited based on the encoding data.

Further, the processor is further configured to perform the following steps: determining a target bitrate based on the predicted capacity value, the target bitrate being a theoretical maximum bitrate for transmitting the encoded stream by the wireless channel; and adjusting the currently configured encoding parameter based on the target bitrate and the predicted encoding parameter.

For specific implementation of the processor in the aerial vehicle, references may be made to the video processing method of the foregoing embodiments corresponding to FIG. 4 or FIG. 5, and details are not described herein again. The aerial vehicle may be a UAV such as a quad-rotor UAV, a six-rotor UAV, or a multi-rotor UAV. The power system may include a motor, an ESC, and a propeller. The motor is configured to drive the aerial vehicle propeller, and the ESC is configured to control a rotation speed of the motor of the aerial vehicle.

Some embodiments of the present disclosure further provides a video processing system which includes a video processing device and an aerial vehicle.

The video processing device is configured to send a flight control instruction to the aerial vehicle, and the flight control instruction is configured to control the aerial vehicle to fly.

The aerial vehicle is configured to execute the flight control instruction which controls the aerial vehicle to fly and controls a photographing device mounted on the aerial vehicle for photographing;

The video processing device is further configured to: obtain a video-to-be-edited, the video-to-be-edited being a video captured by a camera device mounted on the aerial vehicle during the flight of the aerial vehicle; obtain a predicted capacity value of a wireless channel capacity in a current environment; obtain a predicted encoding parameter for the video-to-be-edited; adjust a currently configured encoding parameter based on the predicted capacity value and the predicted encoding parameter; and adjust the video-to-be-edited based on the adjusted encoding parameter to obtain an encoded stream.

Further, the video processing device is configured to: obtain a historical channel capacity value of the wireless channel within a first preset time range; and determine the predicted capacity value of the wireless channel in the current environment based on the historical channel capacity value.

Further, the video processing device is configured to: obtain encoding data by encoding a historical video within a second preset time range; and determine the predicted encoding parameter of the video-to-be-edited based on the encoding data.

Further, the video processing device is configured to: determine a target bitrate based on the predicted capacity value, the target code rate being a theoretical maximum bitrate for transmitting the encoded stream by the wireless channel; adjust the currently configured encoding parameter based on the target bitrate and the predicted encoding parameter.

Further, the video processing device is configured to: determine a target capacity value based on the predicted capacity value and a preset capacity margin; and determine the target bitrate for transmitting the encoded stream by the wireless channel based on the target capacity value and the target bitrate.

Further, the video processing device is configured to: determine the target encoding parameter based on the target bitrate and the predicted encoding parameter; and adjust the currently configured encoding parameter based on the target encoding parameter.

Further, the video processing device is configured to: detect whether a bitrate corresponding to the predicted encoding parameter is greater than the target bitrate; determine an encoding parameter corresponding to the target bitrate to be the target encoding parameter if the detected result is positive; and determine the predicted encoding parameter to be the target encoding parameter if the detected result is negative.

Further, the video processing device is configured to encode a key frame of the video-to-be-edited based on the adjusted encoding parameter to obtain encoding data of the key frame.

Further, the video processing device is configured to encode an ordinary frame of the video-to-be-edited based on the adjusted encoding parameter to obtain encoding data of the ordinary frame.

Further, the video processing device is configured to allocate the obtained encoding data of the key frame to the encoding data of the ordinary frame based on the adjusted encoding parameter.

In the embodiments of the present disclosure, when a video-to-be-edited is obtained, the video processing device obtains a predicted capacity value of a wireless channel capacity in a current environment and a predicted encoding parameter of the video-to-be-edited, and adjusts a currently configured encoding parameter by encoding the video-to-be-edited based on the adjusted encoding parameter to obtain an encoded stream, thereby improving the stability of the video transmission and decreasing the maximum delay jitter.

A computer-readable storage medium is also provided in the embodiments of the present disclosure. The computer-readable storage medium stores a computer program, and the computer program is executed by a processor to implement the video processing methods in the embodiments corresponding to FIG. 4 or FIG. 5. The computer-readable storage medium can also implement the video processing device according to the embodiment of the present disclosure as shown in FIG. 7, and details are not described herein again.

The computer-readable storage medium may be an internal storage unit of the device according to any one of the foregoing embodiments, such as a hard disk or a memory of the device. The computer-readable storage medium may also be an external storage device of the device, such as a plug-in hard disk, a smart media card (SMC), and a secure digital (SD) card, a flash card, etc., provided in the device. Further, the computer-readable storage medium may further include both an internal storage unit of the above device and an external storage device. The computer-readable storage medium is configured to store the computer program and other programs and data required by the terminal. The computer-readable storage medium may also be configured to temporarily store data that has been or will be output.

Those of ordinary skill in the art can understand that all or part of the processes in the method of the foregoing embodiment can be implemented by using a computer program to instruct related hardware. The program can be stored in a computer-readable storage medium. When executing the program, the processes of the above-described method embodiments may be included. The storage medium may be a magnetic disk, an optical disk, a read-only memory (ROM), or a random-access memory (RAM).

The above embodiments are only the preferred embodiments of the present disclosure, and of course, and do not limit the claimed scope of the present disclosure. Therefore, equivalent changes made according to the claims of the present disclosure are within the scope of the present disclosure.

What is claimed is:

1. A video processing method, comprising:
obtaining a video-to-be-edited, the video-to-be-edited being a video captured by a camera device mounted on an aerial vehicle during a flight of the aerial vehicle;
obtaining a predicted capacity value of a wireless channel capacity in a current environment;
obtaining a predicted encoding parameter for the video-to-be-edited;
adjusting a currently configured encoding parameter based on the predicted capacity value and the predicted encoding parameter; and
encoding the video-to-be-edited based on the adjusted encoding parameter to obtain an encoded stream.

2. The method according to claim 1, wherein obtaining a predicted capacity value of a wireless channel capacity in a current environment comprises:
acquiring a historical channel capacity value of a wireless channel within a first preset time range; and
determining the predicted capacity value of the wireless channel in the current environment based on the historical channel capacity value.

3. The method according to claim 1, wherein obtaining a predicted encoding parameter for the video-to-be-edited comprises:
obtaining encoding data of a historical encoded video within a second preset time range; and
determining the predicted encoding parameter of the video-to-be-edited based on the encoding data.

4. The method according to claim 1, wherein adjusting a currently configured encoding parameter based on the predicted capacity value and the predicted encoding parameter comprises:
determining a target bitrate based on the predicted capacity value, the target bitrate being a theoretical maximum bitrate for transmitting the encoded stream by the wireless channel; and
adjusting the currently configured encoding parameter based on the target bitrate and the predicted encoding parameter.

5. The method according to claim 4, wherein determining a target bitrate based on the predicted capacity value comprises:
determining a target capacity value based on the predicted capacity value and a preset capacity margin; and
determining the target bitrate for transmitting the encoded stream by the wireless channel based on the target capacity value.

6. The method according to claim 4, wherein adjusting a currently configured encoding parameter based on the target bitrate and the predicted encoding parameter comprises:
determining a target encoding parameter based on the target bitrate and the predicted encoding parameter; and
adjusting the currently configured encoding parameter based on the target encoding parameter.

7. The method according to claim 6, wherein determining a target encoding parameter based on the target bitrate and the predicted encoding parameter comprises:
detecting whether a bitrate corresponding to the predicted encoding parameter is greater than the target bitrate:
in response to the bitrate corresponding to the predicted encoding parameter being greater than the target bitrate, determining an encoding parameter corresponding to the target bitrate as the target encoding parameter; and
in response to the bitrate corresponding to the predicted encoding parameter not being greater than the target bitrate, determining the predicted encoding parameter as the target encoding parameter.

8. The method according to claim 1, wherein:
the video-to-be-edited comprises: one or more key frames; and
encoding the video-to-be-edited based on the adjusted encoding parameter comprises:
encoding a key frame of the video-to-be-edited based on the adjusted encoding parameter to obtain encoding data of the key frame.

9. The method according to claim 8, wherein:
the video-to-be-edited further comprises: one or more ordinary frames; and
encoding the video-to-be-edited based on the adjusted encoding parameters comprises:
encoding an ordinary frame of the video-to-be-edited based on the adjusted encoding parameter to obtain encoding data of the ordinary frame.

10. The method according to claim 9, wherein encoding an ordinary frame of the video-to-be-edited based on the adjusted encoding parameter comprises:
allocating the obtained encoding data of the key frame to the encoding data of the ordinary frame based on the adjusted encoding parameters.

11. A video processing device, comprising:
a memory configured to store program instructions, and
a processor configured to execute the program instructions stored in the memory and when executed, causing the processor to:
obtain a video-to-be-edited, the video-to-be-edited being a video captured by a camera device mounted on an aerial vehicle during a flight of the aerial vehicle;
obtain a predicted capacity value of a wireless channel capacity in a current environment;
obtain a predicted encoding parameter for the video-to-be-edited;
adjust a currently configured encoding parameter based on the predicted capacity value and the predicted encoding parameter; and
encode the video-to-be-edited based on the adjusted encoding parameter to obtain an encoded stream.

12. The device according to claim 11, wherein the processor is configured to:
obtain a historical channel capacity value of the wireless channel in a first preset time range; and
determine the predicted capacity value of the wireless channel in the current environment based on the historical channel capacity value.

13. The device according to claim 11, wherein the processor is configured to:
acquiring encoding data of a historical encoded video within a second preset time range; and
determine a predicted encoding parameter of the video-to-be-edited based on the encoding data.

14. The device according to claim 11, wherein the processor is configured to:
determine a target bitrate based on the predicted capacity value, the target code bitrate being a theoretical maximum code rate for transmitting the encoded stream by the wireless channel; and
adjust the currently configured encoding parameter based on the target bitrate and the predicted encoding parameter.

15. The device according to claim 14, wherein the processor is configured to:
determine a target capacity value based on the predicted capacity value and a preset capacity margin; and
determine a target bitrate for transmitting the encoded stream by the wireless channel based on the target capacity value.

16. The device according to claim 14, wherein the processor is configured to:
determine a target encoding parameter based on the target bitrate and the predicted encoding parameter; and
adjust the currently configured encoding parameter based on the target encoding parameter.

17. The device according to claim 16, wherein the processor is configured to:
detect whether a bitrate corresponding to the predicted encoding parameter is greater than the target bitrate:
in response to the bitrate corresponding to the predicted encoding parameter being greater than the target bitrate, determine an encoding parameter corresponding to the target bitrate as the target encoding parameter; and
in response to the bitrate corresponding to the predicted encoding parameter not being greater than the target bitrate, determine the predicted encoding parameter as the target encoding parameter.

18. The device according to claim 11, wherein the processor is configured to encode a key frame of the video-to-be-edited based on the adjusted encoding parameter to obtain encoding data of the key frame.

19. The device according to claim 18, wherein the processor is configured to encode an ordinary frame of the video-to-be-edited based on the adjusted encoding parameter to obtain encoding data of the ordinary frame.

20. The device according to claim 19, wherein the processor is configured to allocate the obtained encoding data of the key frame to the encoding data of the ordinary frame based on the adjusted encoding parameter.
